(19) United States
(12) Patent Application Publication
(10) Pub. No.: US 2003/0134050 A1
(43) Pub. Date: Jul. 17, 2003

(54) Electronic part and method for manufacturing the same

(76) Inventors: Tatsuo Kunishi, Takefu-shi (JP); Toshi Numata, Fukui-shi (JP); Junichi Saitoh, Fukui-shi (JP); Yukio Sakabe, Kyoto-shi (JP)

Correspondence Address: DICKSTEIN SHAPIRO MORIN & OSHINSKY LLP, Richard LaCava, 41st Floor, 1177 Avenue of the Americas, New York, NY, 10036-2714, US

(21) Appl. No.: 10/316,092

(22) Filed: Dec. 11, 2002

(30) Foreign Application Priority Data
Dec. 18, 2001 (JP) 2001-385167

(51) Int. Cl. B05D 5/12; B05D 1/36; B05D 1/18

(52) U.S. Cl. 427/443.1; 427/123; 427/404

(57) ABSTRACT

The present invention provides a method for forming a desired plating film on a desired place at a reasonable cost. When workpieces are mixed in a plating solution containing Ni ions with a great number of Zn particles having an average diameter of 1 mm and having an electrochemically base immersion potential with respect to the precipitation potential of Ni, the Zn particles are dissolved and generates electrons, the potential of Cu electrodes in contact with the Zn particles is shifted to an electrochemically base potential side, and hence the Ni ions are precipitated on the electrodes, thereby forming Ni plating films on the surfaces of the electrodes. In a manner equivalent to the above, when Zn particles are immersed in a plating solution containing Sn ions, the Zn particles are dissolved and generates electrons, the potential of the Ni plating films in contact with the Zn particles is shifted to an electrochemically base potential side, and hence the Sn ions are precipitated on the Ni plating films, thereby forming Sn plating films.

### BACKGROUND OF THE INVENTION

1. Field of the Invention

The present invention relates to electroless plating methods, methods for manufacturing electronic parts, and electronic parts, and more particularly, relates to a method for manufacturing chip type electronic parts, such as multilayer capacitors or noise filters, and electronic parts manufactured by the method described above.

2. Description of the Related Art

In electronic parts each composed of a ceramic substrate and electrodes provided thereon, in order to improve heat resistance and solder wettability of the electrodes, plating films have been formed on surfaces of the electrodes by performing nickel or tin plating.

When plating is classified in consideration of film-formation techniques, as has been well known, there have been electroless plating and electroplating in which a metal is precipitated on a workpiece by electrolysis using current passing through a plating solution containing the metal ions. In addition, the electroless plating may be further roughly classified into autocatalytic plating in which metal is precipitated using electrons generated from oxidation reaction of a reductant added to a plating solution and substitution plating using substitution reaction between metal ions in a solution and a metal substrate.

In electroless autocatalytic plating, electrode surfaces must have catalytic activities to promote oxidation reaction of a reductant, and hence surface treatment has been performed for the electrodes by immersing workpieces in a catalytic solution containing palladium (Pd), thereby obtaining catalytic activities on the electrode surfaces.

However, when the workpiece is immersed in the catalytic solution containing Pd, the Pd adheres to areas other than the electrodes so as to impart catalytic activities thereon, and Ni plating proceeds using the Pd as nucleuses for plating. As a result, Ni may also be precipitated on the areas other than the electrodes in some cases. In addition, since a degreasing or an etching step must be performed as pretreatment for providing the Pd catalytic activities, the manufacturing process becomes complicated, and hence this type of plating treatment described above has been primarily performed by electroplating.

On the contrary, in recent years, it was discovered that when a boron compound is used as a reductant, electroless plating can be performed directly on electrodes without catalyzing treatment using Pd, and based on the discovery described above, a technique in which a Ni—B layer, a Ni—P layer, and a Au layer are sequentially formed on the surface of a Cu electrode by electroless plating has been proposed (Japanese Unexamined Patent Application Publication No. 10-135607).

According to this traditional technique, since electroless plating can be performed on workpieces without providing Pd catalytic activities thereon, and the Ni—B layer, Ni—P layer, and Au layer are sequentially formed, the Ni-based layers and the Au layer can be formed only on the electrode surfaces without forming plating films on areas other than the electrodes.

However, of the plating methods described above, the electroplating has the following problems described below.

(1) Plating treatment, so-called barrel plating, has been extensively practiced for small parts such as chip type electronic parts, and in recent years, miniaturization of electronic parts has been desired.

Unfortunately, concomitant with the miniaturization of electronic parts mentioned above, the electronic parts may be caught in a great number of holes formed in the inside wall of the barrel in some cases. Accordingly, the diameter of each hole must be decreased, and at the same time, due to the decreased diameter of said each hole, a plating solution may not flow smoothly.

That is, in the case of the barrel plating, in order to ensure electrical contact with electrodes, plating treatment is performed by placing a great number of conductive media in a barrel apparatus. Hence, concomitant with the miniaturization of electronic parts, conductive media having a diameter of 0.8 mm or less must be used in order to ensure sufficient contact with the electronic parts, and as a result, inexpensive conductive media (a so-called steel shot) containing media having a relatively large diameter such as approximately 1 mm cannot be used. That is, from the economic point of view, plating treatment is preferably performed by placing inexpensive steel shot having various shapes in the barrel apparatus. However, concomitant with the miniaturization of electronic parts, the diameters of holes formed in the barrel must be decreased, and hence conductive media may be sometimes caught in the holes having a decreased diameter thus formed. Accordingly, small and expensive conductive media or steel balls having uniform shapes must be used, resulting in rapid increase in production cost.

(2) In addition, in multiterminal electronic parts each having a great number of terminals, since it has been difficult to supply electricity equally to the individual terminals, thicknesses of plating films formed on the individual terminals are not uniform with each other, that is, variation in thickness of the plating film occurs between the individual terminals. In the case described above, since a necessary minimum film thickness must be ensured, plating conditions for forming a plating film must be set based on the minimum thickness. Accordingly, the film thickness becomes large on the whole, and for example, in the case of Ni plating, the plating film may be peeled off from electrodes by a film stress in some cases.

(3) Furthermore, in the case of low resistance electronic parts such as varistors using a ceramic material for a substrate, since electrons flow on the surface of the ceramic substrate while electroplating is performed, a plating metal is abnormally precipitated on the surface of the ceramic substrate. In particular, since current distribution is complicated in barrel plating, it has been difficult to avoid the above-described abnormal precipitation of a plating metal on the ceramic substrate.

On the contrary, in electroless plating disclosed in Japanese Unexamined Patent Application Publication No. 10-135607, since plating treatment can be performed without providing Pd catalytic activity to an electrode surface, a desired plating film can be formed only on the electrode. However, since expensive dimethylamine borane ((CH₃)₂NHBH₃; hereinafter referred to as “DMAB”) is generally used as a reductant, when this technique is applied to methods for manufacturing many electronic parts used in various applications, a problem may occur in that the production cost is significantly increased.

Furthermore, in the case of tin plating, since having poor autocatalytic function, tin cannot be precipitated spontaneously and continuously by general electroless plating. Accordingly, there has been a problem in that it is difficult to obtain a tin film having an optional thickness by a current electroless plating technique.

### SUMMARY OF THE INVENTION

Accordingly, in consideration of the problems described above, the present invention was made, and an object of the present invention is to provide a method for manufacturing electronic parts, in which a desired plating film can be formed only on a desired place at a reasonable cost, and a reliable and inexpensive electronic part manufactured by using the manufacturing method described above.

When small parts such as chip type electronic parts are electroplated by barrel plating in a traditional manner, plating treatment must be performed by placing conductive media having a small diameter in the barrel, as described above, and since plating metal is also precipitated on the surfaces of the conductive media, the amount of the metal thus precipitated is unnecessarily used, resulting in significant increase in production cost. In addition, in the case of multiterminal electronic parts, for example, a problem in that distribution of film thickness becomes broader may occur. As a result, it has been believed that it is difficult for electroplating to solve the problems described above from the technical point of view.

Accordingly, through intensive research by the inventors of the present invention focusing on electroless plating in order to obtain a method for forming a plating film only on a desired place, a method was found which can precipitate a metal on electrodes by chemical reaction performed between conductive media and metal ions in a plating solution without any addition of a reductant thereto. In the method described above, workpieces are mixed in the plating solution with conductive media having an electrochemically base immersion potential with respect to the precipitation potential of a precipitable metal, which is to be precipitated, so that the conductive media are brought into contact with electrodes of the workpieces, and as a result, the reversible potential of each electrode is shifted to an electrochemically base potential side by influence of the precipitation potential, thereby precipitating the metal on the electrodes as described above.

The present invention was made based on the method described above, and a method for manufacturing electronic parts, according to the present invention, comprises a first mixing step of mixing workpieces, each comprising a substrate and electrodes provided thereon, with first conductive media in a first plating solution, wherein the first plating solution comprises precipitable metal ions, and the first conductive media have an electrochemically base immersion potential with respect to the precipitation potential of the precipitable metal ions, whereby first plating films are formed on the electrodes by electroless plating.

In addition, as the first mixing step described above, the workpieces with the first conductive media are preferably mixed with each other by stirring the first plating solution filled in a plating bath for performing plating treatment for small workpieces.

Accordingly, the first mixing step may comprise placing the workpieces and the first conductive media in a container, and rotating, rocking, tilting, vibrating the container in the first plating solution filled in the plating bath so that the workpieces and the first conductive media are brought into contact with each other.

In conventional electroplating, the diameter of each aperture formed in a barrel apparatus is preferably set to relatively large; otherwise it becomes difficult for current to flow smoothly, and as a result, the current distribution is disordered. Accordingly, it has been believed that conductive media having a small diameter or steel shot having various shapes are not preferably used. However, in electroless plating, even when the diameter of each aperture formed in a barrel apparatus is decreased, serious problems relating to the reaction are not likely to occur, and hence the diameter described above can be as small as possible. Accordingly, the degree of freedom of shape of conductive media is large, and hence conductive media having various shapes can be used. That is, by using conductive media having an average diameter of approximately 1.0 mm, the case in which the conductive media are caught in the apertures in the barrel can be avoided, and even when small electronic parts are manufactured, expensive conductive media having a small diameter or steel balls having uniform shapes are not necessary to use.

Accordingly, in the present invention, the first conductive media preferably have an average diameter of 1.0 mm or more. Concerning the average diameter, the average diameter of a sphere is only described; however, when the conductive media have various shapes other than a sphere, the average diameter is considered to be an average maximum diameter of the shape.

Furthermore, in the method for manufacturing the electronic parts, according to the present invention, the electrodes may be formed of one of Cu, a Cu alloy, Ag, and a Ag alloy, the first conductive media may comprise metal particles each containing at least one compound selected from the group consisting of Al, Zn, Fe, Mn, V, Cr, Ta, Nb, Ga, Cd, In, and an alloy thereof, and the first plating solution may comprise an ionizable Ni compound. By mixing the workpieces with the first conductive media in the first plating solution described above for performing the electroless plating, the first plating films primarily composed of Ni (Ni plating films or Ni alloy plating films) are formed on the electrodes.

That is, since Al, Zn, Fe, Mn, V, Cr, Ta, Nb, Ga, Cd, In, and an alloy thereof each have an electrochemically base immersion potential with respect to that of Cu, a Cu alloy, Ag, a Ag alloy, forming the electrodes, when the metal particles composed of Al, Zn, Fe, Mn, V, Cr, Ta, Nb, Ga, Cd, In, or an alloy thereof mentioned above are brought into contact with the workpieces, the metal particles are dissolved and/or have influences on these electrode materials (Cu, a Cu alloy, Ag, or a Ag alloy). As a result, the reversible potential of the Cu, a Cu alloy, Ag, or a Ag alloy is shifted to an electrochemically base potential side, and electrochemically noble Ni or Ni alloy is precipitated on the electrodes, thereby forming the first plating films.

Since the immersion potential of conductive media is largely changed by the hydrogen ion exponent (pH) of a plating solution and the presence of a complexing agent in an alkaline plating solution, the number of types of usable conductive media is increased.

Furthermore, the method for manufacturing electronic parts, according to the present invention, may further comprise a second mixing step of mixing the workpieces, which are provided with the first plating films on the electrodes thereof, with second conductive media in a second plating solution, wherein the second conductive media comprise metal particles containing at least one of Al, Zn, Fe, Mn, V, Cr, Ta, Nb, and an alloy thereof, and the second plating solution comprises an ionizable Sn compound, whereby second plating films are formed on the first plating films by electroless plating.

That is, according to the manufacturing method described above, since the Ni or Ni alloy forming the first plating films is influenced by the Al, Zn, Fe, Mn, V, Cr, Ta, Nb, or an alloy thereof having an electrochemically base immersion potential, the reversible potential of the first plating films (Ni plating films) is shifter to an electrochemically base potential side, and the metal is precipitated on the first plating films, thereby forming the second plating films (Sn plating films or Sn alloy plating films) on the first plating films.

In the method for manufacturing the electronic parts, according to the present invention, the electrodes may be formed of one of Ni, a Ni alloy, Cu, a Cu alloy, Ag, and a Ag alloy, the first conductive media may comprise metal particles each containing at least one compound selected from the group consisting of Al, Zn, Fe, Mn, V, Cr, Ta, Nb, and an alloy thereof, and the first plating solution may contain at least an ionizable Sn compound. By mixing the workpieces with the first conductive media in the first plating solution described above for performing the electroless plating, the first plating films (Sn plating films or Sn alloy plating films) are formed on the electrodes.

That is, since the Ni, Ni alloy, Cu, Cu alloy, Ag, or Ag alloy forming the electrodes is influenced by the Al, Zn, Fe, Mn, V, Cr, Ta, Nb, and alloy thereof having an electrochemically base immersion potential, the reversible potential of the electrodes is shifted to an electrochemically base potential side, precipitation of metal starts on the electrodes, and as a result, the first plating films (Sn plating films or Sn alloy plating films) are formed. That is, although it has been believed that Sn plating or Sn alloy plating using a Sn—Pb alloy, a Sn—Ag alloy, a Sn—Bi alloy, or the like cannot be suitably performed by electroless plating since having no autocatalytic function, they can be easily performed by using the electroless plating of the present invention.

As described above, in the present invention, the conductive media having an electrochemically base immersion potential with respect to the precipitation potential of the precipitable metal are mixed in the plating solution with the workpieces, and the metal is precipitated on the electrodes by shifting the potential of the electrode materials to an electrochemically base potential side. Accordingly, in the present invention, various combinations among precipitable metals, conductive media, and electrode materials can be appropriately selected.

That is, in the method for manufacturing the electronic parts, according to the present invention, the electrodes may be formed of Ni, a Ni alloy, Cu, a Cu alloy, Ag, or an Ag alloy, the first conductive media may comprise metal particles each containing at least one compound selected from the group consisting of Al, Zn, Fe, Mn, V, Cr, Ta, Nb, Ga, Cd, In, and an alloy thereof, and the first plating solution may contain an ionizable Co compound. By mixing the workpieces with the first conductive media in the first plating solution described above for performing the electroless plating, the first plating films composed of Co or a Co alloy are formed on the electrodes.

In addition, in the method for manufacturing the electronic parts, according to the present invention, the electrodes may be formed of Ni, a Ni alloy, Cu, a Cu alloy, Ag, or an Ag alloy, the first conductive media may comprise metal particles each containing at least one compound selected from the group consisting of Al, Zn, Fe, Ni, a Ni alloy, Sn, Mn, V, Cr, Ta, Nb, Ga, Cd, In, Co, Mo, Pb, and an alloy thereof, and the first plating solution may comprise an ionizable Pd compound or an ionizable Au compound. By mixing the workpieces with the first conductive media in the first plating solution described above for performing the electroless plating, the first plating films composed of Pd, Au, or an alloy thereof are formed on the electrodes.

Furthermore, according to the present invention, the electrodes may be formed of Ni, a Ni alloy, Ag, or an Ag alloy, the first conductive media may comprise metal particles each containing at least one compound selected from the group consisting of Al, Zn, Fe, Ni, a Ni alloy, Sn, Mn, V, Cr, Ta, Nb, Ga, Cd, In, Co, Mo, Pb, and an alloy thereof, and the first plating solution may comprise an ionizable Cu compound. By mixing the workpieces with the first conductive media in the first plating solution described above for performing the electroless plating, the first plating films composed of the Cu are formed on the electrodes. In addition, the first conductive media may comprise metal particles each containing at least one compound selected from the group consisting of Al, Zn, Fe, Ni, a Ni alloy, Sn, Mn, V, Cr, Ta, Nb, Ga, Cd, In, Co, Mo, Pb, and an alloy thereof, and the first plating solution may comprise an ionizable Ag compound. By mixing the workpieces with the first conductive media in the first plating solution described above for performing the electroless plating, the first plating films composed of the Ag are formed on the electrodes.

An electronic part of the present invention is manufactured by one of the manufacturing methods described above.

That is, the electronic part according to the present invention, in which plating films are formed only on electrodes by electroless plating using a desired metal, can be easily obtained.

In particular, since Sn can be continuously precipitated to form Sn plating films or Sn alloy plating films, a highly reliable electronic part having desired Ni/Sn multilayer plating films can be easily formed at reasonable cost.

In addition, the present invention provides a method for performing electroless plating, which comprises a first mixing step of mixing workpieces, each comprising a substrate and portions to be plated, with first conductive media in a first plating solution, wherein the first plating solution comprises a precursor of a precipitable metal, and the first conductive media have an electrochemically base immersion potential with respect to the precipitation potential of the precipitable metal, whereby first plating films are formed on the portions.

In the electroless plating method according to the present invention, the first mixing step preferably comprises placing the workpieces and the first conductive media in a container, and rotating, rocking, tilting, or vibrating the container in the first plating solution filled in a plating bath so that the workpieces and the first conductive media are brought into contact with each other. In addition, the first conductive media preferably have an average diameter of 1.0 mm or more.

In the electroless plating method of the present invention described above, the first conductive media may comprise metal particles each containing at least one compound selected from the group consisting of aluminum, zinc, iron, manganese, vanadium, chromium, thallium, niobium, gallium, cadmium, indium, and an alloy thereof, the precursor of the precipitable metal may comprise an ionizable nickel compound, and the portions to be plated may comprise one of copper, a copper alloy, silver, and a silver alloy, whereby the first plating films comprising nickel are formed on the portions.

The electroless plating method of the present invention described above may further comprise a second mixing step of mixing the workpieces, which are provided with the first plating films on the portions thereof, with second conductive media in a second plating solution, wherein the second conductive media comprise metal particles each containing at least one compound selected from the group consisting of aluminum, zinc, iron, manganese, vanadium, chromium, thallium, niobium, and an alloy thereof, and the second plating solution comprises an ionizable tin compound used as a precursor of a precipitable metal, whereby second plating films containing tin or a tin compound are formed on the first plating films.

In the electroless plating method of the present invention described above, the first conductive media may comprise metal particles each containing at least one compound selected from the group consisting of aluminum, zinc, iron, manganese, vanadium, chromium, thallium, niobium, and an alloy thereof, the precursor of the precipitable metal may comprise an ionizable tin compound, and the portions to be plated may contain one of nickel, a nickel alloy, copper, a copper alloy, silver, and a silver alloy, whereby the first plating films containing tin or a tin alloy are formed on the portions.

In the electroless plating method of the present invention described above, the first conductive media may comprise metal particles each containing at least one compound selected from the group consisting of aluminum, zinc, iron, manganese, vanadium, chromium, thallium, niobium, gallium, cadmium, indium, and an alloy thereof, the precursor of the precipitable metal may comprise an ionizable cobalt compound, and the portions to be plated may contain one of nickel, a nickel alloy, copper, a copper alloy, silver, and a silver alloy, whereby the first plating films containing cobalt or a cobalt alloy are formed on the portions.

In the electroless plating method of the present invention described above, the first conductive media may comprise metal particles each containing at least one compound selected from the group consisting of aluminum, zinc, iron, nickel, a nickel alloy, tin, manganese, vanadium, chromium, thallium, niobium, gallium, cadmium, indium, cobalt, molybdenum, lead, and an alloy thereof, the precursor of the precipitable metal may comprise an ionizable palladium compound or an ionizable gold compound, and the portions to be plated may contain one of nickel, a nickel alloy, copper, a copper alloy, silver, and a silver alloy, whereby the first plating films containing palladium, gold, or an alloy thereof are formed on the portions.

In the electroless plating method of the present invention described above, the first conductive media may comprise metal particles each containing at least one compound selected from the group consisting of aluminum, zinc, iron, nickel, a nickel alloy, tin, manganese, vanadium, chromium, thallium, niobium, gallium, cadmium, indium, cobalt, molybdenum, lead, and an alloy thereof, the precursor of the precipitable metal may comprise an ionizable copper compound, and the portions to be plated may contain one of nickel, a nickel alloy, silver, and a silver alloy, whereby the first plating films containing copper are formed on the portions.

In the electroless plating method of the present invention described above, the first conductive media may comprise metal particles each containing at least one compound selected from the group consisting of aluminum, zinc, iron, nickel, a nickel alloy, tin, manganese, vanadium, chromium, thallium, niobium, gallium, cadmium, indium, cobalt, molybdenum, lead, and an alloy thereof, the precursor of the precipitable metal may comprise an ionizable silver compound, and the portions to be plated may contain one of nickel, a nickel alloy, copper, and a copper alloy, whereby the first plating films containing silver are formed on the portions.

### BRIEF DESCRIPTION OF THE DRAWINGS

FIG. 1 is a cross-sectional view showing one embodiment of an electronic part manufactured by a manufacturing method of the present invention.

### DESCRIPTION OF THE PREFERRED EMBODIMENTS

Next, embodiments of the present invention will be described with reference to the FIGURE.

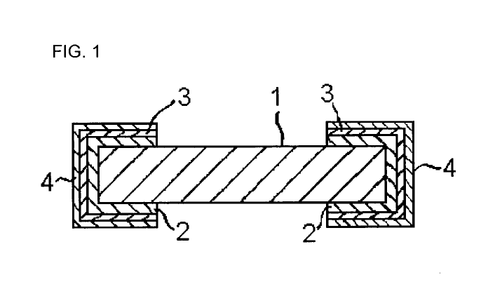

FIG. 1 is a cross-sectional view schematically showing one embodiment of a chip type electronic part manufactured by a method of the present invention.

In the FIGURE, a ceramic substrate 1 in the form of a plate is composed of a ceramic material, such as barium titanate or lead titanate zirconate (PZT), and at two ends of the ceramic substrate 1, electrode portions 2 composed of Cu, a Cu alloy, Ag, Ag—Pd, or the like are formed. In addition, on the surfaces of the electrode portions 2, Ni plating films 3 are provided, and on the surfaces thereof, Sn plating films 4 are provided.

Next, the method for manufacturing the electronic parts will be described.

First, a ceramic sintered body processed by predetermined forming and firing processes is cut to produce the ceramic substrate 1 in the form of a plate, and subsequently, by known methods, an electrode material such as Cu, a Cu alloy, Ag, or Ag—Pd is applied to the two ends of the ceramic substrate 1 and is fired, thereby forming the electrode portions 2 at the two ends of the ceramic substrate 1.

Next, in this embodiment, the electrode potential is shifted to an electrochemically base potential side by conductive media, and at the same time, a metal is precipitated on the surfaces of the electrodes by oxidation-reduction reaction with metal ions in a plating solution, thereby forming the Ni plating film 3 and the Sn plating film 4 on the surface of each of the electrode portions 2.

Hereinafter, methods for forming the Ni plating film 3 and the Sn plating film 4 will be described in detail.

(1) Ni Plating Film 3

In this embodiment, Zn particles, preferably 1 mm in average diameter and having an electrochemically base immersion potential with respect to the precipitation potential of Ni which is a precipitable metal to be precipitated, are immersed in a plating solution containing an ionizable Ni compound and are brought into contact with workpieces to be plated by mixing and stirring so that a potential of each of the electrodes composed, for example, of Cu, a Cu alloy, Ag, or Ag—Pd, is shifter to a base potential side, thereby forming the Ni plating films 3 on the electrode surfaces.

That is, when the Zn particles having an electrochemically base immersion potential with respect to that of a precipitable metal to be precipitated are immersed in a plating solution containing metal (Ni) ions, the Zn particles are dissolved in the plating solution and generates electrons as shown by the chemical formula (1).

Zn→Zn²⁺+2e− (1)

In addition, by mixing and stirring the Zn particles with the workpieces, the Zn particles are brought into contact with the electrodes so that the electrode potential is shifted to an electrochemically base potential side, and at the same time, as shown in the chemical formula (2), Ni ions which are electrochemically noble compared to the Zn particles are precipitated on the electrodes by reduction reaction, thereby forming the Ni plating films 3.

Ni²⁺+2e⁻→Ni (2)

(2) Sn Plating Film 4

The Sn plating film 4 is formed in accordance with the same principle as described above for the Ni plating film 3.

That is, when Zn particles, preferably 1 mm in average diameter and having an electrochemically base immersion potential with respect to the precipitation potential of Sn which is a precipitable metal to be precipitated, are immersed in a plating solution containing an ionizable Sn compound, the Zn particles are dissolved in the plating solution and generates electrons in the same manner as described above (see the above chemical formula (1)).

In addition, by mixing and stirring the Zn particles with the workpieces, the Zn particles are brought into contact with the electrodes so that the electrode potential is shifted to an electrochemically base potential side, and at the same time, as shown in the chemical formula (3), Sn ions which are electrochemically noble compared to the Zn particles are precipitated on the Ni plating films 3 by reduction reaction of the Sn ions, thereby forming the Sn plating films 4.

Sn²⁺+2e⁻→Sn (3)

As described above, in this embodiment, the Zn particles, which are brought into contact with the electrode surfaces, are allowed to react with Ni or Sn, which are the precipitable metals to be precipitated, thereby forming the Ni plating films 3 on electrodes whose potential is shifted to an electrochemically base potential side and the Sn plating films 4 on the Ni plating films 3.

Accordingly, when small electronic parts are manufactured, conductive media having a small diameter of 0.8 mm or less or steel balls having uniform shapes are not necessarily used, which are generally used in a barrel electroplating method, and hence desired small electronic parts can be manufactured at reasonable cost.

In addition, when Ni plating films and Sn plating films are formed for multiterminal electronic parts, it has been difficult to equally control electricity supply conditions for individual terminals, and as a result, it has been difficult to obtain uniform plating thicknesses between the individual terminals. However, in this embodiment, plating can be approximately uniformly performed for all electrodes, which are brought into contact with a plating solution, and hence an electronic part having uniform film thicknesses between individual terminals can be obtained.

In a manner different from that in the past, since surface treatment is not performed by Pd catalyst, plating is not performed on non-metal areas other than the electrodes, and hence plating films can be formed only on desired portions.

In addition, in a conventional substitution electroless plating method, since a metal is precipitated by substitution reaction between an electrode material and a precipitable metal to be precipitated, when the precipitable metal covers the electrodes, the reaction stops, and as a result, relatively thin films can only be formed; however, in this embodiment, since the chemical reaction (oxidation-reduction reaction) between the conductive media and the precipitable metal is utilized, by adjusting an amount of the conductive media supplied into a plating solution, the film thickness can be easily controlled.

The present invention is not limited to the embodiment described above. In the embodiment described above, as the conductive media, the Zn particles are used; however, a material may be used having an electrochemically base immersion potential with respect to the precipitation potential of Ni or Sn, which are precipitable metals, and for example, when a Ni plating film is formed, by using one of Al, Fe, Mn, V, Cr, Ta, Nb, Ga, Cd, In, and an alloy thereof as the conductive media, the same effects and advantages as described above can be obtained. In addition, when a Sn plating film is formed, by using one of Al, Fe, Mn, V, Cr, Ta, Nb, and an alloy thereof as the conductive media, the same effects and advantages as described above can be obtained. In the embodiment described above, the Sn plating film is formed on the Ni plating film; however, by the same methods as described above, a Sn alloy plating film such as a Sn—Pb, Sn—Ag, or Sn—Bi alloy may be formed on the Ni plating film, and a Sn plating film or Sn alloy plating film may be formed on electrodes composed of Ni, Cu, Ag, or Ag—Pd by the electroless plating described above using the electrodes as an underlying electrode.

Furthermore, in the present invention, the metal is precipitated on the surfaces of the electrode portions 2 having an electrochemical potential shifted to a base potential side by the chemical reaction between the precipitable metal and the conductive media brought into contact with the electrode portions 2 as described above, and hence various combinations can be available by optionally selecting electrode materials and conductive media in consideration of a precipitable metal.

Hereinafter, the cases in which Co or a Co alloy, Cu, Ag, Pd or a Pd alloy, and Au are used as a precipitable metal will be described.

(1) Co or Co Alloy

As the conductive media having an electrochemically base immersion potential with respect to the precipitation potential of Co or a Co alloy, which is a precipitable metal, metal particles each comprising at least one of Al, Zn, Fe, Mn, V, Cr, Ta, Nb, Ga, Cd, and In are used. Subsequently, by immersing the metal particles described above into a plating solution containing an ionizable Co compound, electrons are generated while the metal particles are dissolved, the Co ions are reduced, and as a result, the Co or Co alloy is precipitated on electrodes which are formed of Ni, an Ni alloy, Cu, a Cu alloy, Ag, or Ag—Pd and which are in contact with the metal particles, thereby forming Co plating films or Co alloy plating films.

(2) Cu

As the conductive media having an electrochemically base immersion potential with respect to the precipitation potential of Cu which is a precipitable metal, metal particles comprising at least one of Al, Zn, Fe, Ni, a Ni alloy, Sn, Mn, V, Cr, Ta, Nb, Ga, Cd, In, Co, Mo, and Pb are used. Subsequently, by immersing the metal particles described above into a plating solution containing an ionizable Cu compound, electrons are generated while the metal particles are dissolved, the Cu ions are reduced, and as a result, the Cu is precipitated on electrodes which are formed of Ni, an Ni alloy, Ag, or Ag—Pd and which are in contact with the metal particles, thereby forming Cu plating films.

(3) Ag

As the conductive media having an electrochemically base immersion potential with respect to the precipitation potential of Ag which is a precipitable metal, metal particles comprising at least one of Al, Zn, Fe, Ni, a Ni alloy, Sn, Mn, V, Cr, Ta, Nb, Ga, Cd, In, Co, Mo, and Pb are used. Subsequently, by immersing the metal particles described above into a plating solution containing an ionizable Ag compound, electrons are generated while the metal particles are dissolved, the Ag ions are reduced, and as a result, the Ag is precipitated on electrodes which are formed of Ni, an Ni alloy, Cu, a Cu alloy and which are in contact with the metal particles, thereby forming Ag plating films.

(4) Pd or Pd Alloy

As the conductive media having an electrochemically base immersion potential with respect to the precipitation potential of Pd or a Pd alloy, which is a precipitable metal, metal particles comprising at least one of Al, Zn, Fe, Ni, a Ni alloy, Sn, Mn, V, Cr, Ta, Nb, Ga, Cd, In, Co, Mo, and Pb are used. Subsequently, by immersing the metal particles described above into a plating solution containing an ionizable Pd compound, electrons are generated while the metal particles are dissolved, the Pd ions are reduced, and as a result, the Pd or Pd alloy is precipitated on electrodes which are formed of Ni, an Ni alloy, Cu, a Cu alloy, Ag, or Ag—Pd and which are in contact with the metal particles, thereby forming Pd plating films.

(5) Au

As the conductive media having an electrochemically base immersion potential with respect to the precipitation potential of Au which is a precipitable metal, metal particles comprising at least one of Al, Zn, Fe, Ni, a Ni alloy, Sn, Mn, V, Cr, Ta, Nb, Ga, Cd, In, Co, Mo, and Pb are used. Subsequently, by immersing the metal particles described above into a plating solution containing an ionizable Au compound, electrons are generated while the metal particles are dissolved, the Au ions are reduced, and the Au is precipitated on electrodes which are formed of Ni, an Ni alloy, Cu, a Cu alloy, Ag, or Ag—Pd and which are in contact with the metal particles, thereby forming Au plating films.

The results of the above (1) to (5) are summarized in Table 1.

TABLE 1

| | Precipitable | | |
|---|---|---|---|
| No. | Metal | Conductive Media | Electrode Material |
| 1 | Sn | Al, Zn, Fe, Mn, V, Cr, Ta, | Ni, Cu, Ag, Ag—Pd |
| | or Sn Alloy) | Nb | |
| 2 | Ni | Al, Zn, Fe, Mn, V, Cr, Ta, | Cu, Ag, Ag—Pd |
| | (or Ni Alloy) | Nb, Ga, Cd, In | |
| 3 | Co | | Ni, Cu, Ag, Ag—Pd |
| | (or Co Alloy) | | |
| 4 | Cu | Al, Zn, Fe, Ni (or Ni alloy), | Ni, Ag, Ag—Pd |
| 5 | Ag | Sn, Mn, V, Cr, Ta, Nb, Ga, | Ni, Cu, |
| 6 | Pd | Cd, In, Co, Mo, Pb | Ni, Cu, Ag, A—Pd |
| | (or Pd Alloy) | | |
| 7 | Au | | |

As can be seen from Table 1, desired plating treatment can be performed using various combinations of a precipitable metal, conductive media, and an electrode material, and as a result, the present invention can be widely applied to plating treatment for various electronic parts used for various applications, such as printed circuit boards, in addition to chip type electronic parts.

According to the present invention described above in detail, an electronic part in which plating films having a desired thickness formed on electrode surfaces by oxidation reduction reaction between conductive media and a precipitable metal can be manufactured regardless of autocatalytic functions.

Next, examples of the present invention will be described in detail.

### FIRST EXAMPLE

### Example 1

In Example 1, 30,000 workpieces 3.2 mm long, 1.6 mm wide, and 1.0 mm thick each composed of a ceramic substrate provided with Cu electrodes at two ends thereof were formed.

Next, the workpieces described above were placed in a container having an internal volume of 0.001 m³ filled with a plating solution (first plating solution) having the plating composition described below, and at the same time, 10,000 Zn particles having an average diameter of 1 mm were received in the container and were then stirred for 30 minutes, thereby forming Ni Plating films on the surfaces of the Cu electrodes by electroless plating.

Composition of First Plating Solution

| | |
|---|---|
| Metal Salt: Nickel chloride: | 30.0 kg/m³ |
| Complexing Agent: Sodium citrate: | 10.0 kg/m³ |
| Sodium glycolate: | 10.0 kg/m³ |
| PH: | 4.2 |
| Bath Temperature: | 85° C. |

Next, the workpieces processed by the electroless plating described above were placed in a container filled with a plating solution (second plating solution) having the plating composition described below, and in a manner equivalent to that described above, 80 Zn particles having an average diameter of 1 mm were received in the container and were then stirred for 30 minutes for forming Sn Plating films on the Ni plating films by electroless plating. As a result, samples of Example 1 were prepared.

Composition of Second Plating Solution

| | |
|---|---|
| Metal Salt: Stannous sulfate: | 5.5 kg/m³ |
| Complexing Agent: Sodium gluconate: | 140.0 kg/m³ |
| Additive: Polyethylene glycol (molecular weight of 7,500): | 1.0 kg/m³ |
| p-Anisaldehyde: | 0.1 kg/m³ |
| 37% aqueous solution of formaldehyde: | 0.6 kg/m³ |
| PH: | 6.0 |
| Bath Temperature: | 35° C. |

### Example 2

Ag—Pd electrodes were formed on two ends of each ceramic substrate equivalent to that described in Example 1, and electroless plating was preformed so as to sequentially form Ni plating films and Sn plating films on the Ag—Pd electrodes in a manner equivalent to that described in Example 1, thereby forming samples of Example 2.

### Example 3

Ag electrodes were formed on two ends of each ceramic substrate equivalent to that described in Example 1, and electroless plating was preformed so as to sequentially form Ni plating films and Sn plating films on the Ag electrodes in a manner equivalent to that described in Example 1, thereby forming samples of Example 3.

### Example 4

By using ceramic substrates each having a length of 0.6 mm, a width of 0.3 mm, and a thickness of 0.3 mm, samples of Example 4 were formed by performing electroless plating so as to sequentially form Ni plating films and Sn plating films on Cu electrodes in a manner equivalent to that described in Example 1.

In Table 2, the film thicknesses of the individual examples described above are shown.

Related to this, the measurement of film thickness was performed by using a fluorescence x-ray thickness meter (SEA5120 manufactured by Seiko Instrument Inc.).

TABLE 2

| | | Electrode | Film Thickness (μm) | |
|---|---|---|---|---|
| | | Material | Ni Plating Film | Sn Plating Film |
| Example | 1 | Cu (1) | 5.23 | 3.24 |
| | 2 | Ag—Pd | 5.01 | 3.55 |
| | 3 | Ag | 4.35 | 3.51 |
| | 4 | Cu (2) | 3.90 | 1.16 |

As can be seen from the results of each example shown in Table 2, it is confirmed that the Ni plating films can be formed without adding a reductant to the plating solution, and that an Sn plating film having a desired film thickness can be obtained in spite of a poor autocatalytic function of Sn.

In addition, as can be seen from the results of Example 4 shown in Table 1, it is found that Ni plating films and Sn plating films can be formed for small chip type electronic parts by placing Zn particles having an average diameter of 1 mm into a container for mixing with the workpieces.

### SECOND EXAMPLE

By using ceramic substrates 0.6 mm long, 0.3 mm wide, and 0.3 mm thick, Ni plating films were formed on Cu electrodes in a manner equivalent to that described in Example 1 of the first embodiment, thereby forming workpieces to be plated. Next, the workpieces thus formed were placed in a container filled with a plating solution (third plating solution) having the plating composition described below, and 1,000 Zn particles having an average diameter of 1 mm were placed in the container and stirred for 30 minutes in a manner as described above for forming Sn—Pb Plating films on the surfaces of the Ni plating films by electroless plating, thereby forming samples of Examples 11 to 14.

Composition of Third Plating Solution

| | |
|---|---|
| Metal Salt: Stannous sulfate: | 31.1 kg/m³ |
| Lead (II) acetate: | 17.9 kg/m³ |
| Complexing Agent: Sodium gluconate: | 109.1 kg/m³ |
| Disodium ethylenediaminetetraacetate: | 18.5 kg/m³ |
| Additive: polyethylene glycol (molecular weight of 7,500): | 1.0 kg/m³ |
| P-Anisaldehyde: | 0.1 kg/m³ |
| 37% aqueous solution of formaldehyde: | 0.6 kg/m³ |
| PH: | 8.0 |
| Bath Temperature: | 35° C. |

The results are summarized in Table 3.

TABLE 3

| | | | | | Pb Content |
|---|---|---|---|---|---|
| | | | Film Thickness (μm) | | of Sn—Pb |
| | | Electrode | Ni Plating | Sn—Pb | Plating Film |
| | | Material | Film | Plating Film | (wt %) |
| Example | 11 | Cu | 4.02 | 1.41 | 39.2 |
| | 12 | Cu | 3.51 | 1.68 | 37.8 |
| | 13 | Cu | 3.96 | 1.80 | 38.1 |
| | 14 | Cu | 3.66 | 1.20 | 38.5 |

As can be seen in Table 3, as is the formation of the Sn plating film described above, it is found that desired Sn—Pb plating films can be formed on the surfaces of the Ni plating films when small chip type electronic parts are formed.

As described above in detail, according to the method for manufacturing electronic parts of the present invention, the electronic parts having uniform plating film thicknesses can be formed by performing plating treatment on the workpieces each comprising the substrate and electrodes. In the method described above, since the workpieces are mixed in the plating solution with the conductive media having an electrochemically base immersion potential with respect to the precipitation potential of the precipitable metal for forming the plating films on the electrodes by electroless plating, the electrodes of the workpieces are brought into contact with the conductive media, the reversible potential of the electrodes is shifted to an electrochemically base potential side by influence of the precipitation potential, and as a result, the metal can be precipitated on the electrodes by oxidation reduction reaction between the conductive media and the precipitable metal without any addition of a reductant to the plating solution. In addition, since the metal is precipitated by electroless plating, in a manner different from that of electroplating, the metal is not precipitated on non-metal portions other than the electrode portions, and even in the case of the multiterminal electronic parts, plating films having desired uniform film thicknesses can be formed only on the electrode portions thereof. Furthermore, since the uniformity of the plating film is superior, significant increase in cost can be avoided.

In addition, since being mixed with each other by stirring the plating solution, the conductive media and the workpieces are efficiently brought into contact with each other even when the workpieces are small products, and hence the electrode surface can be easily shifted to an electrochemically base potential side.

Furthermore, since the average diameter of the conductive media is set to 1.0 mm, even when a barrel container, which is generally used for electroplating, is used for the electroless plating described above, the case in which the conductive media are caught in apertures formed in the barrel can be avoided. In addition, it is not necessary to use expensive conductive media having a small diameter, and even when small electronic parts are manufactured, production can be performed without significant increase in cost.

In particular, when the electrodes are formed of Cu, a Cu alloy, Ag, or a Ag alloy, and the workpieces having the electrodes described above are mixed with the conductive media comprising metal particles containing at least one compound selected from the group consisting of Al, Zn, Fe, Mn, V, Cr, Ta, Nb, Ga, Cd, In, and an alloy thereof in a plating solution containing an ionizable Ni compound, first plating films are formed on the electrodes by electroless plating. In the step of forming the first plating films described above, highly pure Ni can be precipitated on the electrodes while the contents of impurities are decreased as small as possible.

In addition, when the workpieces described above are mixed with the conductive media comprising metal particles containing at least one compound selected from the group consisting of Al, Zn, Fe, Mn, V, Cr, Ta, Nb, and an alloy thereof in a plating solution containing at least an ionizable Sn compound, second plating films (Sn plating films or Sn alloy films) are formed on the first plating films by electroless plating. Accordingly, although Sn has poor autocatalytic function, Sn plating films can be formed on the Ni plating films or Ni alloy plating films by electroless plating.

Furthermore, without adding any reductant for forming the Ni or Sn plating films, the plating treatment can be easily performed at a reasonable cost.

In addition, according to the present invention, even when the electrodes are formed of Ni, a Ni alloy, Cu, a Cu alloy, Ag, or a Ag alloy, electroless plating can be easily performed at a reasonable cost, and electroless plating of Sn, which has not been practiced industrially, can be easily performed at reasonable cost.

In the present invention, in the case in which Co (or Co alloy), Cu, Ag, Pd (or Pd alloy), and Au are used as the precipitable metals, when appropriate conductive media and electrode materials are variously combined therewith, desired plating treatment can be performed. Accordingly, in addition to the chip type electronic parts, the present invention can be widely applied to plating treatment for electronic parts used for various applications such as printed circuit boards.

In addition, since the electronic part of the present invention is manufactured by the manufacturing method described above, surface treatment by a catalytic solution containing Pd, which has been performed in conventional electroless plating, is not necessary, and an electronic part in which plating films having uniform thickness are formed only on electrode portions can be easily obtained.

In particular, a Ni/Sn multilayer plating film or Ni—Sn alloy plating film can be formed by electroless plating, and hence a highly reliable electronic part having superior performance can be obtained at reasonable cost.

Although the present invention has been described in relation to particular embodiments thereof, modifications and other uses will become apparent to those skilled in the art. Accordingly, it is preferred that the present invention not be limited by the specific disclosure herein, but only by the appended claims.

What is claimed is:

1. A method for manufacturing electronic parts, the method comprising:
mixing workpieces with first conductive media in a first plating solution, each workpiece comprising a substrate and an electrode provided thereon, the first plating solution comprising precipitable metal ions, and the first conductive media having an electrochemically base immersion potential with respect to the precipitation potential of the precipitable metal ions; and
forming first plating films on the electrodes by electroless plating.

2. The method for manufacturing electronic parts according to claim 1, wherein the mixing step comprises placing the workpieces and the first conductive media in a container, and rotating, rocking, tilting, or vibrating the container in the first plating solution filled in a plating bath so that the workpieces and the first conductive media are brought into contact with each other.

3. The method for manufacturing electronic parts according to claim 1, wherein the first conductive media have an average diameter of 1.0 mm or more.

4. The method for manufacturing electronic parts according to claim 1,
wherein the electrodes comprise one of copper and silver,
the first conductive media comprise metal particles each containing at least one compound selected from the group consisting of aluminum, zinc, iron, manganese, vanadium, chromium, thallium, niobium, gallium, cadmium, indium, and an alloy thereof, and
the first plating solution comprises an ionizable nickel compound.

5. The method for manufacturing electronic parts according to claim 4, wherein the first plating films comprise nickel.

6. The method for manufacturing electronic parts according to claim 4, further comprising:
mixing the workpieces having the first plating films on the electrodes thereof with second conductive media in a second plating solution, the second conductive media comprising metal particles containing at least one of aluminum, zinc, iron, manganese, vanadium, chromium, thallium, niobium, and an alloy thereof, and the second plating solution comprising an ionizable tin compound; and
forming second plating films on the first plating films by electroless plating.

7. The method for manufacturing electronic parts according to claim 6, wherein the second plating films comprise tin.

8. The method for manufacturing electronic parts according to claim 1,
wherein the electrodes comprise one of nickel, copper, and silver,
the first conductive media comprise metal particles each containing at least one compound selected from the group consisting of aluminum, zinc, iron, manganese, vanadium, chromium, thallium, niobium, and an alloy thereof, and
the first plating solution comprises an ionizable tin compound.

9. The method for manufacturing electronic parts according to claim 8, wherein the first plating films comprise tin.

10. The method for manufacturing electronic parts according to claim 1,
wherein the electrodes comprise one of nickel, copper, and silver,
the first conductive media comprise metal particles each containing at least one compound selected from the group consisting of aluminum, zinc, iron, manganese, vanadium, chromium, thallium, niobium, gallium, cadmium, indium, and an alloy thereof, and
the first plating solution comprises an ionized cobalt compound, whereby the first plating films comprising cobalt are formed on the electrodes.

11. The method for manufacturing electronic parts according to claim 1,
wherein the electrodes comprise one of nickel, copper, and silver,
the first conductive media comprise metal particles each containing at least one compound selected from the group consisting of aluminum, zinc, iron, nickel, a nickel alloy, tin, manganese, vanadium, chromium, thallium, niobium, gallium, cadmium, indium, cobalt, molybdenum, lead, and an alloy thereof, and
the first plating solution comprises one of an ionizable palladium compound and an ionizable gold compound, whereby the first plating films comprising one of palladium and gold are formed on the electrodes.

12. The method for manufacturing electronic parts according to claim 1,
wherein the electrodes comprise one of nickel and silver,
the first conductive media comprise metal particles each containing at least one compound selected from the group consisting of aluminum, zinc, iron, nickel, a nickel alloy, tin, manganese, vanadium, chromium, thallium, niobium, gallium, cadmium, indium, cobalt, molybdenum, lead, and an alloy thereof, and
the first plating solution comprises an ionizable copper compound, whereby the first plating films comprising copper are formed on the electrodes.

13. The method for manufacturing electronic parts according to claim 1,
wherein the electrodes comprise one of nickel and copper,
the first conductive media comprise metal particles each containing at least one compound selected from the group consisting of aluminum, zinc, iron, nickel, a nickel alloy, tin, manganese, vanadium, chromium, thallium, niobium, gallium, cadmium, indium, cobalt, molybdenum, lead, and an alloy thereof, and
the first plating solution comprises an ionizable silver compound, whereby the first plating films comprising silver are formed on the electrodes.

14. An electronic part manufactured by a method for manufacturing electronic parts according to claim 1.

15. A method for performing electroless plating, the method comprising:
mixing workpieces with first conductive media in a first plating solution, each workpiece comprising a substrate and at least one portion to be plated, the first plating solution comprising a precursor of a precipitable metal, and the first conductive media having an electrochemically base immersion potential with respect to the precipitation potential of the precipitable metal; and
forming first plating films on the at least one portion to be plated.

16. The method for performing electroless plating according to claim 15, wherein the mixing step comprises placing the workpieces and the first conductive media in a container, and a rotating, rocking, tilting, or vibrating the container in the first plating solution filled in a plating bath so that the workpieces and the first conductive media are brought into contact with each other.

17. The method for performing electroless plating according to claim 15, wherein the first conductive media have an average diameter of 1.0 mm or more.

18. The method for performing electroless plating according to claim 15, wherein
the first conductive media comprise metal particles each containing at least one compound selected from the group consisting of aluminum, zinc, iron, manganese, vanadium, chromium, thallium, niobium, gallium, cadmium, indium, and an alloy thereof,
the precursor of the precipitable metal comprises an ionizable nickel compound, and
the at least one portion to be plated comprises one of copper and silver, whereby the first plating films comprising nickel are formed on the at least one portion.

19. The method for performing electroless plating according to claim 18, further comprising:
mixing the workpieces having the first plating films on the at least one portion thereof with second conductive media in a second plating solution, the second conductive media comprising metal particles each containing at least one compound selected from the group consisting of aluminum, zinc, iron, manganese, vanadium, chromium, thallium, niobium, and an alloy thereof, and the second plating solution comprising an ionizable tin compound as a precursor of a precipitable metal; and
forming second plating films comprising tin on the first plating films.

20. The method for performing electroless plating according to claim 15, wherein
the first conductive media comprise metal particles each containing at least one compound selected from the group consisting of aluminum, zinc, iron, manganese, vanadium, chromium, thallium, niobium, and an alloy thereof,
the precursor of the precipitable metal comprises an ionizable tin compound, and
the at least one portion to be plated comprises one of nickel, copper, and silver, whereby the first plating films comprising tin are formed on the at least one portion.

21. The method for performing electroless plating according to claim 15, wherein
the first conductive media comprise metal particles each containing at least one compound selected from the group consisting of aluminum, zinc, iron, manganese, vanadium, chromium, thallium, niobium, gallium, cadmium, indium, and an alloy thereof,
the precursor of the precipitable metal comprises an ionizable cobalt compound, and
the portions to be plated comprises one of nickel, copper, and silver, whereby the first plating films comprising cobalt are formed on the at least one portion.

22. The method for performing electroless plating according to claim 15, wherein
the first conductive media comprise metal particles each containing at least one compound selected from the group consisting of aluminum, zinc, iron, nickel, a nickel alloy, tin, manganese, vanadium, chromium, thallium, niobium, gallium, cadmium, indium, cobalt, molybdenum, lead, and an alloy thereof,
the precursor of the precipitable metal comprises one of an ionizable palladium compound and an ionizable gold compound, and
the portions to be plated comprise one of nickel, copper, and silver, whereby the first plating films comprising one of palladium and gold are formed on the at least one portion.

23. The method for performing electroless plating according to claim 15, wherein
the first conductive media comprise metal particles each containing at least one compound selected from the group consisting of aluminum, zinc, iron, nickel, a nickel alloy, tin, manganese, vanadium, chromium, thallium, niobium, gallium, cadmium, indium, cobalt, molybdenum, lead, and an alloy thereof,
the precursor of the precipitable metal comprises an ionizable copper compound, and
the at least one portion to be plated comprises one of nickel and silver, whereby the first plating films comprising copper are formed on the at least one portion.

24. The method for performing electroless plating according to claim 15, wherein
the first conductive media comprise metal particles each containing at least one compound selected from the group consisting of aluminum, zinc, iron, nickel, a nickel alloy, tin, manganese, vanadium, chromium, thallium, niobium, gallium, cadmium, indium, cobalt, molybdenum, lead, and an alloy thereof,
the precursor of the precipitable metal comprises an ionizable silver compound, and
the at least one portion to be plated comprises one of nickel and copper, whereby the first plating films comprising silver are formed on the at least one portion.
